(19) United States
(12) Patent Application Publication
(10) Pub. No.: US 2022/0258310 A1
(43) Pub. Date: Aug. 18, 2022

(54) Hub Wheel Bearing Removal Tool-Bit

(71) Applicant: Said Benzekri, Timmins (CA)

(72) Inventor: Said Benzekri, Timmins (CA)

(21) Appl. No.: 17/581,522

(22) Filed: Jan. 21, 2022

Related U.S. Application Data
(60) Provisional application No. 63/150,836, filed on Feb. 18, 2021.

(51) Int. Cl. B25B 21/00; B25B 21/02

(52) U.S. Cl. CPC B25B 21/002; B60B 31/00; B25B 21/023

(57) ABSTRACT

A tool for removing a hub wheel bearing assembly from a steering knuckle includes a main element and at least one hub engaging element. The tool is used in combination with a power tool, such as a pneumatic hammer. The tool is particularly useful for removing hub wheel bearing assemblies that are rusted and/or corroded to steering knuckles. The hub wheel bearing assembly removal tool may remove the hub wheel bearing assembly from the steering knuckle without causing any damage to hub wheel bearing assembly, the steering knuckle, or any parts attached to it; thus, making the hub wheel bearing assembly removal an ideal tool for not only vehicle owners but car dealers, vehicle repair shops, and insurance companies also.

### CROSS-REFERENCE TO RELATED APPLICATION

The present application is related to and claims priority to U.S. Provisional Patent Application No. 63/150,836 filed Feb. 18, 2021, which is incorporated by reference herein in its entirety.

### BACKGROUND OF THE INVENTION

The following includes information that may be useful in understanding the present disclosure. It is not an admission that any of the information provided herein is prior art nor material to the presently described or claimed inventions, nor that any publication or document that is specifically or implicitly referenced is prior art.

### TECHNICAL FIELD

The present invention relates generally to the field of vehicle repair tools of existing art and more specifically relates to a hub wheel bearing assembly removal tool.

### RELATED ART

Automotive vehicles include components that generally need to be replaced or serviced after a period of time. Such components include wheel bearing assemblies which typically include bolts, a wheel hub, a rotor, and wheel bearings. When the wheel bearing assembly has become so worn as to require replacement, it is frequently found to be affixed tightly to a steering knuckle by dirt, corrosion and rusting, making removal of the bearing extremely difficult.

Current methods of removal are not desirable. For example, currently the wheel hub bearing assembly may be removed by hand with slide hammers or other manual means. This can take hours of work, often requires the help of penetrating fluids or torches, frequently leads to damage of the vehicle and injury to the individual performing the removal, significant time loss, and other undesired consequences. Further, often times, even after all the time spent on the removal of the wheel bearing assembly, the current tools and techniques are unsuccessful. Thus, a suitable solution is desired.

### SUMMARY OF THE INVENTION

In view of the foregoing disadvantages inherent in the known vehicle repair tool art, the present disclosure provides a novel hub wheel bearing assembly removal tool and method. The general purpose of the present disclosure, which will be described subsequently in greater detail, is to provide a tool used to remove a hub wheel bearing assembly that is particularly difficult to remove from a steering knuckle; such as a rusted and/or corroded hub wheel bearing assembly.

A tool for removing a hub wheel bearing assembly from a steering knuckle is disclosed herein. The tool is particularly used in combination with a power tool including a tool receiver. The hub wheel bearing assembly and the steering knuckle may include aligned openings for receiving bolts therethrough. The tool may include a main element and at least one hub engaging element. The main element may include a first distal end opposite a first proximal end and a first shaft therebetween. The first distal end may be configured for engagement with the tool receiver, thereby attaching the main element to the power tool. The first proximal end may include a first attachment mechanism.

The at least one hub engaging element may include a second proximal end opposite a second distal end and a second shaft therebetween. The second proximal end may include a means of engaging with one of the aligned openings, thereby attaching the at least one hub engaging element to the one of the aligned openings. The second distal end may include a second attachment mechanism configured to attach to the first attachment mechanism, thereby placing the power tool in communication with the hub wheel bearing assembly such that a force applied to the tool (from the power tool) is transferred to the hub wheel bearing assembly, forcing the hub wheel bearing assembly from the steering knuckle.

According to another embodiment, a method of removing hub wheel bearing assembly from a steering knuckle using a tool in combination with a power tool is also disclosed herein. The method includes providing the tool as above; engaging the second proximal end of the at least one hub engaging element with the one of the aligned openings, thereby attaching the at least one hub engaging element to the hub wheel bearing assembly; engaging the first distal end of the main element with the tool receiver, thereby attaching the main element to the power tool; attaching the second attachment mechanism to the first attachment mechanism thereby placing the power tool in communication with the hub wheel bearing assembly; switching the power tool on; and applying a force to the tool via the power tool, the force being transferred to the hub wheel bearing assembly thereby forcing the hub wheel bearing assembly from the steering knuckle.

For purposes of summarizing the invention, certain aspects, advantages, and novel features of the invention have been described herein. It is to be understood that not necessarily all such advantages may be achieved in accordance with any one particular embodiment of the invention. Thus, the invention may be embodied or carried out in a manner that achieves or optimizes one advantage or group of advantages as taught herein without necessarily achieving other advantages as may be taught or suggested herein. The features of the invention which are believed to be novel are particularly pointed out and distinctly claimed in the concluding portion of the specification. These and other features, aspects, and advantages of the present invention will become better understood with reference to the following drawings and detailed description.

### BRIEF DESCRIPTION OF THE DRAWINGS

The figures which accompany the written portion of this specification illustrate embodiments and methods of use for the present disclosure, a hub wheel bearing assembly removal tool and method, constructed and operative according to the teachings of the present disclosure.

FIG. 1 is a perspective view of a tool having a main element for attachment to a pneumatic hammer and a hub engaging element for attachment to aligned openings of a hub wheel bearing assembly and a steering knuckle, according to an embodiment of the present disclosure.

FIG. 2 is a perspective view of the tool of FIG. 1 illustrating the main element attached to the pneumatic hammer at one end and the hub engaging element at an opposite end and the hub engaging element being inserted within the aligned openings of the hub wheel bearing assembly and the steering knuckle, according to an embodiment of the present disclosure.

FIG. 3 is a cross-sectional view taken along line 3-3 of FIG. 2 illustrating the tool having the main element for attachment to the pneumatic hammer and the hub engaging element for attachment to the aligned openings of the hub wheel bearing assembly and the steering knuckle, according to an embodiment of the present disclosure.

FIG. 4 is a cross-sectional view taken along line 3-3 of FIG. 2 illustrating the main element attached to the pneumatic hammer at the one end and the hub engaging element at the opposite end and the hub engaging element inserted within the aligned openings of the hub wheel bearing assembly and the steering knuckle, according to an embodiment of the present disclosure.

FIG. 5 is a perspective view of the hub engaging element and the main element, according to an embodiment of the present disclosure.

FIG. 6 is a front view of the hub engaging element including a socket with a hexagonal shaped interior and the main element including a protrusion with a hexagonal shaped exterior, according to an embodiment of the present disclosure.

FIG. 7 is a top view of the main element inserted within the hub engaging element, according to an embodiment of the present disclosure.

FIG. 8 is a cross-sectional view taken along line 8-8 of FIG. 7 illustrating the main element inserted within the hub engaging element, according to an embodiment of the present disclosure.

FIG. 9 is a perspective view of the tool provided in a kit and including the main element and a set of hub engaging elements, according to an embodiment of the present disclosure.

FIG. 10 is a flow diagram illustrating a method of removing a hub wheel bearing assembly from a steering knuckle using a tool in combination with a power tool, according to an embodiment of the present disclosure.

The various embodiments of the present invention will hereinafter be described in conjunction with the appended drawings, wherein like designations denote like elements.

### DETAILED DESCRIPTION

As discussed above, embodiments of the present disclosure relate to vehicle repair tools and more particularly to a hub wheel bearing assembly removal tool and method as used to remove a hub wheel bearing assembly that is particularly difficult to remove from a steering knuckle. Preferably, the hub wheel bearing assembly removal tool may be configured to easily remove a hub wheel bearing assembly from any vehicle; foreign or domestic. The hub wheel bearing assembly removal may remove the hub wheel bearing assembly from the steering knuckle without causing any damage to hub wheel bearing assembly, the steering knuckle, or any parts attached to it, thus making the hub wheel bearing assembly removal an ideal tool for not only vehicle owners but car dealers, vehicle repair shops, and insurance companies also.

Generally, the hub wheel bearing assembly removal tool may include five pieces: one main piece that attaches to a power tool, such as a pneumatic hammer, and four different pieces that selectively interface with the main piece. The four different pieces may include two different sizes and two different thread pitches so as to enable the hub wheel bearing assembly removal tool to be used with any vehicle. The hub wheel bearing assembly removal tool may fit into an opening in the hub wheel bearing assembly and an (aligned) opening of the steering knuckle (after removing mounting bolts connecting the hub wheel bearing assembly to the steering knuckle). With a pneumatic hammer, a user may be able to hammer the hub wheel bearing assembly from behind to push it off the steering knuckle.

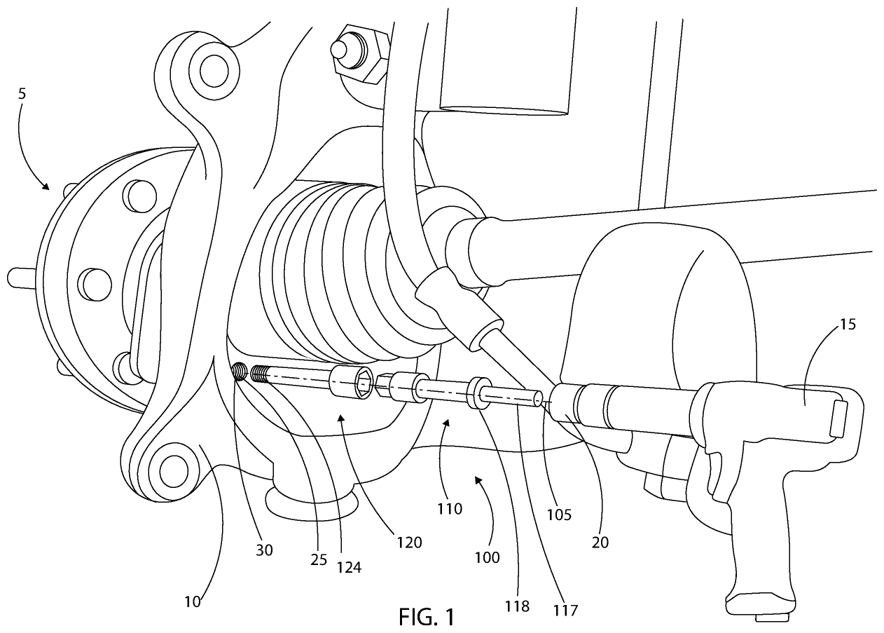

Referring now more specifically to the drawings by numerals of reference, there is shown in FIGS. 1-9, various views of a tool 100. As shown in FIGS. 1-4, the tool 100 may be used for removing a hub wheel bearing assembly 5 from a steering knuckle 10. Particularly, the tool 100 may be useful in removing hub wheel bearing assemblies that are especially difficult to remove from steering knuckles, such as hub wheel bearing assemblies that have corroded and/or rusted to the steering knuckles.

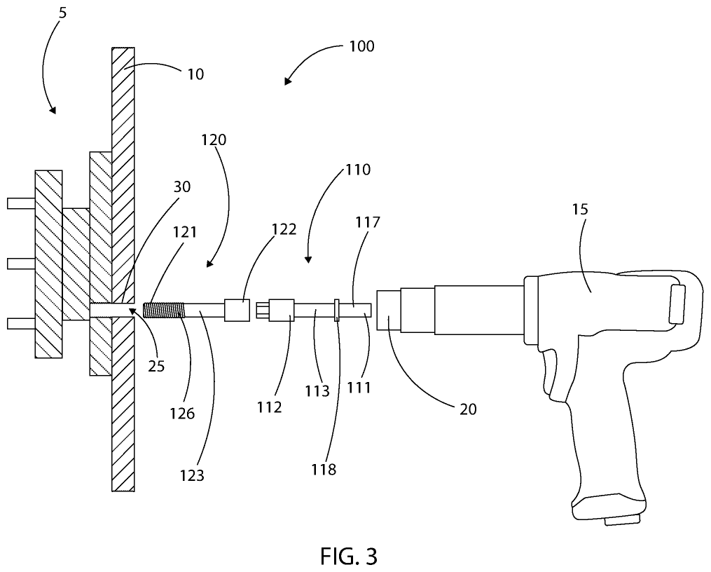

As shown in FIG. 1 and FIG. 3 particularly, the hub wheel bearing assembly 5 and the steering knuckle 10 include aligned openings 25 (separate openings in each of the hub wheel bearing assembly 5 and the steering knuckle 10 that are aligned for installation of the hub wheel bearing assembly 5 to the steering knuckle 10) for receiving bolts (for original securement of the hub wheel bearing assembly 5 to the steering knuckle 10—it should be understood that the bolts may not be used with the present invention). Particularly, as shown in FIG. 1 and FIG. 3, the aligned openings 25 may include female threads 30. Different makes and models of hub wheel bearing assemblies and steering knuckles may include differing numbers of aligned openings. It is contemplated that the tool 100 may be used with any of these aligned openings 25 on any location on the hub wheel bearing assembly 5/steering knuckle 10.

As shown in FIGS. 1-4, the tool 100 may be used in combination with a power tool 15 for removing the hub wheel bearing assembly 5 from the steering knuckle 10. The power tool 15 may include a tool receiver 20. It should be understood that the term “power tool” is meant to encompass any tool operated via a mechanism other than solely manual labor. In some embodiments, the power tool 15 may be a pneumatic tool. For example, preferably, and as shown in FIGS. 1-4, the power tool 15 may be a pneumatic hammer. The tool 100 may comprise a main element 110 and at least one hub engaging element 120. The main element 110 may be configured for attachment to the power tool 15 at one end, and to engage with the at least one hub engaging element 120 at an opposite end. The at least one hub engaging element 120 may engage with one of the aligned openings 25 (at any location on the hub wheel bearing assembly 5/steering knuckle 10), placing the power tool 15 in communication with the hub wheel bearing assembly 5 such that a force applied to the tool 100 is transferred to the hub wheel bearing assembly 5, forcing the hub wheel bearing assembly 5 from the steering knuckle 10.

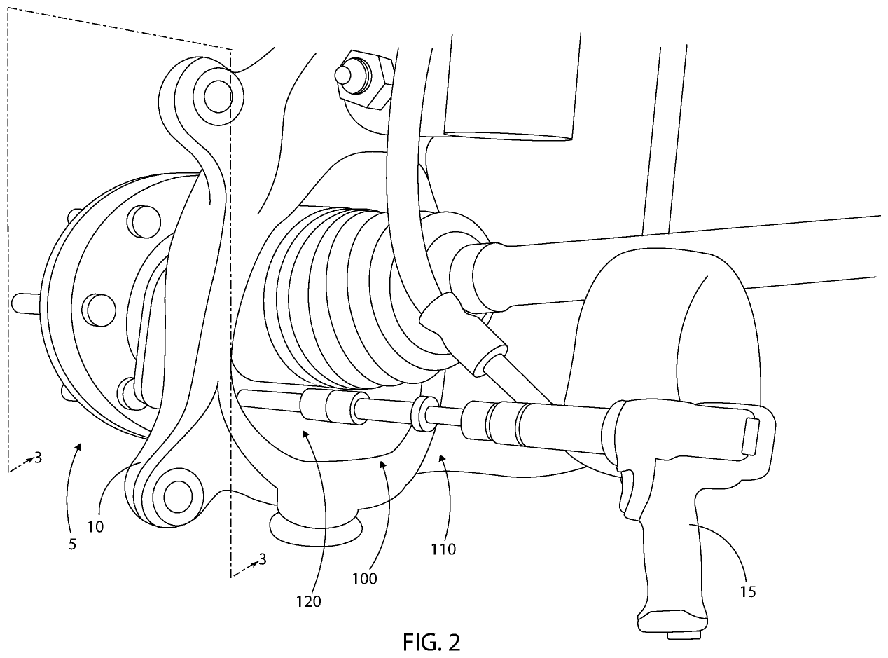

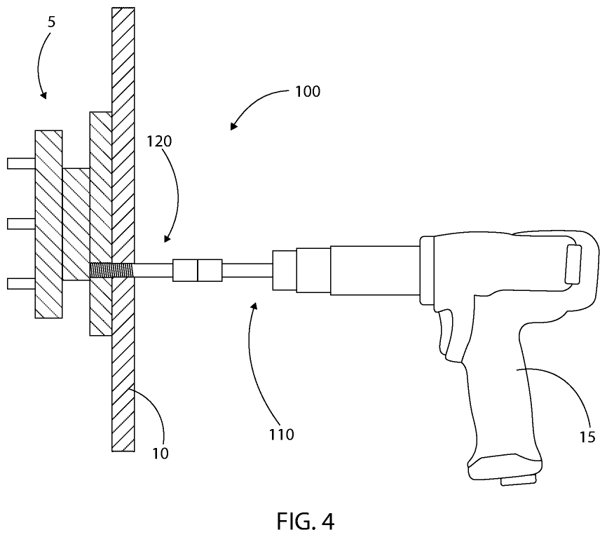

Preferably, as shown in FIG. 1, the main element 110, at least one hub engaging element 120 and the one of the aligned openings 25 may share a common axis 105 in use (all elements 110, 120, 25 attached and being used to remove the hub wheel bearing assembly 5 as shown in FIG. 2 and FIG. 4) and the power tool 15 may be configured to apply a force coaxial to the common axis 105. As above, the power tool 15 may be a pneumatic hammer. As such, the pneumatic hammer may coaxially ‘hammer’ (deliver forceful blows) to the one of the aligned openings 25 (via the tool 100) to loosen the hub wheel bearing assembly 5 from the steering knuckle 10.

As shown in FIG. 3, the main element 110 may include a first distal end 111 opposite a first proximal end 112 and a first shaft 113 therebetween and the at least one hub engaging element 120 may include a second proximal end 121 opposite a second distal end 122 and a second shaft 123 therebetween. As shown in FIGS. 1-4, the first distal end 111 may be configured for engagement with the tool receiver 20, thereby attaching the main element 110 to the power tool 15. In some embodiments, the tool receiver 20 may be a tool-bit slot. In this embodiment, the tool receiver 20 may include a tool-bit shaft 117 configured for insertion into the tool-bit slot. As shown, the first shaft 113 may include an outer diameter greater than an outer diameter of the tool-bit shaft 117. Further, the first distal end 111 may include a tool-bit collar 118 in between the tool-bit shaft 117 and the first shaft 113 configured to lock the tool-bit shaft 117 in the tool-bit slot. Particularly, the tool-bit collar 118 may engage with a chuck in the tool-bit slot. As shown, the tool-bit shaft 117 may include a cylindrical shape.

The second proximal end 121 of the at least one hub engaging element 120 may include a means of engaging with one of the aligned openings 124, thereby attaching the at least one hub engaging element 120 to the one of the aligned openings 25. For example, as shown, and as discussed above, the aligned openings 25 may each include female threads 30. As such, the second proximal end 121 may include male threads 126 configured for threadable engagement with the female threads 30 of the one of the aligned openings 25. Particularly, as shown in FIG. 2 and FIG. 4, the second proximal end 121 of the at least one hub engaging element 120 may be inserted into the one of the aligned openings 25 and twisted to mate the male threads 126 of the at least one hub engaging element 120 with the female threads 30 of the one of the aligned openings 25. The at least one hub engaging element 120 may take the place of a previously inserted bolt. Particularly, all bolts (as discussed above) may be removed from the aligned openings 25 and the at least one hub engaging element 120 may be inserted in one bolt's place.

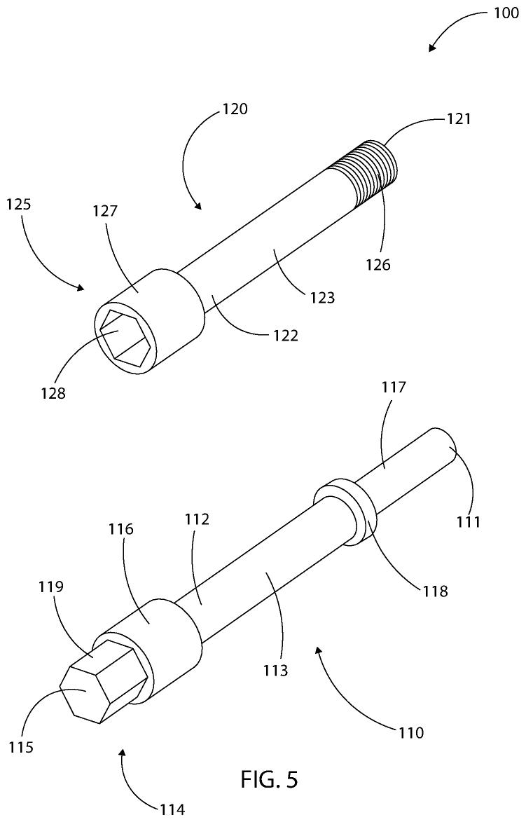

Referring now more specifically to FIGS. 5-8, illustrating exemplary means of attaching the main element 110 to the at least one of the hub engagement element 120. As shown, the first proximal end 112 may include a first attachment mechanism 114 and the second distal end 122 may include a second attachment mechanism 125 configured to attach to the first attachment mechanism 114, thereby placing the power tool 15 in communication with the hub wheel bearing assembly 5 (when the at least one of the hub engagement element 120 is inserted within the one of the aligned openings 25) such that a force applied to the tool 100 is transferred to the hub wheel bearing assembly 5, forcing the hub wheel bearing assembly 5 from the steering knuckle 10 (as discussed above).

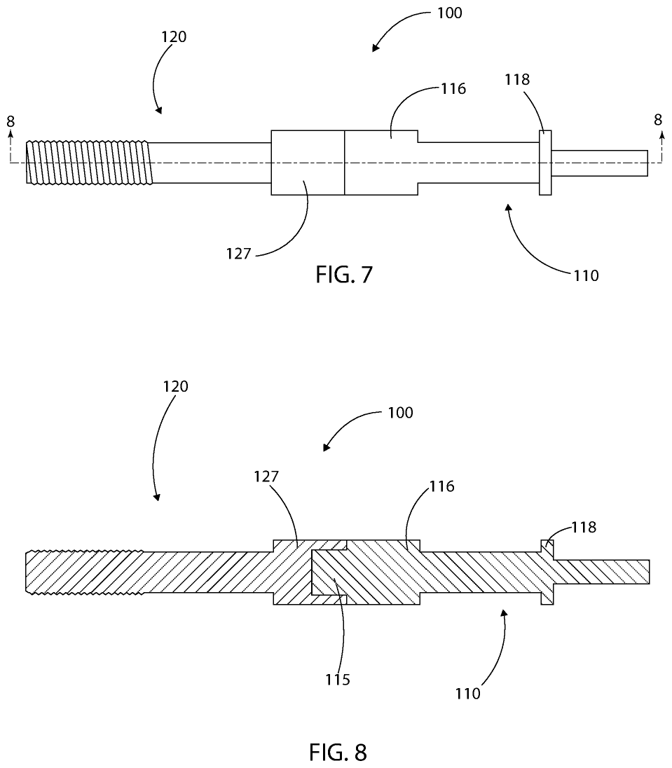

In some embodiments, the first attachment mechanism 114 may include a protrusion 115 and the second attachment mechanism 125 may include a socket 127 for receiving the protrusion 115 (through insertion as shown in FIGS. 7-8). It should however be appreciated that the attachment mechanisms 114, 125 are not limited to this configuration. Further, in some embodiments, the first attachment mechanism 114 may include the socket 127 and the second attachment mechanism 125 may include the protrusion 115.

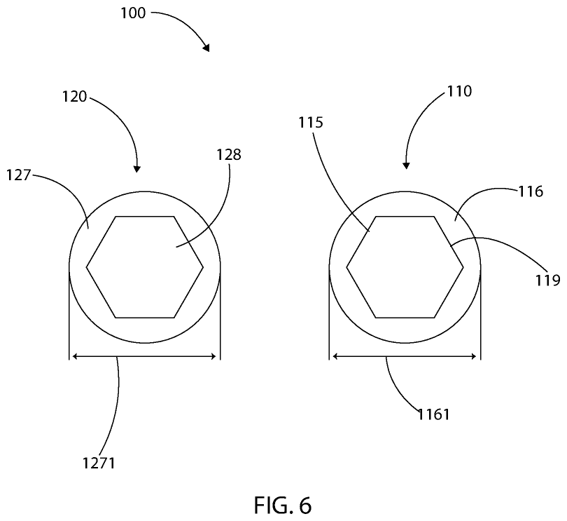

As shown in FIGS. 5-6, the socket 127 may be a hexagonal socket including a hexagonal shaped interior 128 and the protrusion 115 may include a hexagonal shape exterior 119 configured to interface with the hexagonal shaped interior 128. In some embodiments, as shown, the socket 127 may include a cylindrical exterior. In other embodiments, the socket 127 may include a hexagonal exterior also. Further, it should be appreciated that the socket 127 and the protrusion 115 are not limited to hexagonal shapes. For example, the socket 127 and the protrusion 115 may include (but are not limited to) square shapes, pentagon shapes, circular shapes, cruciform shapes, etc.

In some embodiments, the protrusion 115 may be secured within the socket 127 via friction (friction fit). Other means of attachment may also be contemplated. For example, the socket 127 and the protrusion 115 may include corresponding slots and grooves for locking the protrusion 115 within the socket 127 (not illustrated). In some embodiments, the first proximal end 112 may further include a collar 116 located behind the protrusion 115. As shown in FIG. 6, the collar 116 may include an outer diameter 1161 equal to (or at least substantially equal to) an outer diameter 1201 of the socket 120. As shown in FIGS. 7-8, when the main element 110 is secured to the at least one hub engaging element 120, a rear of the socket 127 and a front of the collar 116 may abut.

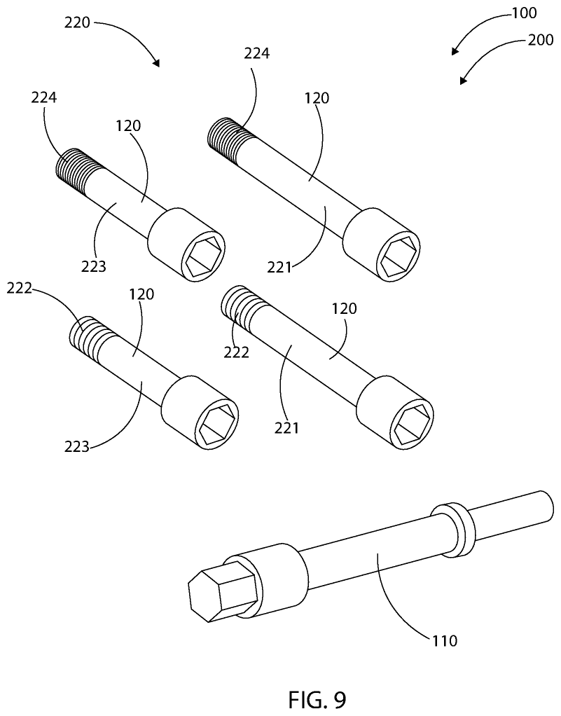

Referring specifically to FIG. 9, as shown, the at least one hub engagement element 120 may include a set 220 of hub engagement elements 120. As such, in some embodiments, the tool 100 may be provided in a kit 200 including the main element 110 and the set 220 of hub engagement elements 120. As shown in FIG. 9, the set 220 of hub engagement elements 120 may include four hub engagement elements 120. The four hub engagement elements 120 may be provided in two different sizes and two different thread pitches.

For example, one of the set 220 of hub engagement elements 120 may include a first size 221 and a first thread pitch 222; another may include the first size 221 and a second thread pitch 224; another may include a second size 223 and the first thread pitch 222; and another may include the second size 223 and the second thread pitch 224. As shown in FIG. 9, the first size 221 may be larger than the second size 223 and the first thread pitch 222 may be larger (includes a larger distance between threads) than the second thread pitch 224. It should be appreciated that the set 220 of hub engagement elements 120 is not limited to two sizes and two thread pitches however; for example, the set 220 of hub engagement elements 120 may include more than two or less than two sizes and thread pitches. Further, the set 220 of hub engagement elements 120 may include other differences, such as (but not limited to) different thickness, different diameters, different shapes, different fasteners, etc.

Providing the set 220 of hub engagement elements 120 may allow the tool 100 to be used with any hub wheel bearing assembly 5/steering knuckle 10 combination. For example, a user may choose an appropriate hub engagement element from the set 220 of hub engagement elements 120 based on at least one characteristic of the aligned openings 25. For instance, thread pitch, depth, diameter, type of fastener, etc. Further, the user may choose the appropriate hub engagement element 120 based on least one of (but not limited to) make, model, manufacturer, manufacture year, style, shape, size, etc. of a vehicle to which the hub wheel bearing assembly 5/steering knuckle 10 belongs (“belongs to” may mean the vehicle the hub wheel bearing assembly 5/steering knuckle 10 is attached to or was manufactured for use with).

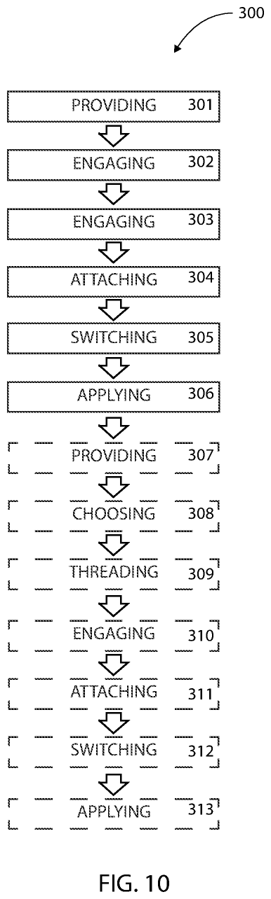

Referring now to FIG. 10 showing a flow diagram illustrating a method 300 of removing hub wheel bearing assembly from a steering knuckle using a tool in combination with a power tool, according to an embodiment of the present disclosure. In particular, the method 300 may include one or more components or features of the tool 100 and/or the kit 200 as described above. As illustrated, the method 300 may include the steps of: step one 301, providing the tool as above; step two 302, engaging the second proximal end of the at least one hub engaging element with the one of the aligned openings, thereby attaching the at least one hub engaging element to the hub wheel bearing assembly; step three 303, engaging the first distal end of the main element with the tool receiver, thereby attaching the main element to the power tool; step four 304, attaching the second attachment mechanism to the first attachment mechanism thereby placing the power tool in communication with the hub wheel bearing assembly; step five 303, switching the power tool on; and step 306, applying a force to the tool via the power tool, the force being transferred to the hub wheel bearing assembly thereby forcing the hub wheel bearing assembly from the steering knuckle.

Further steps may include: step seven 307, again providing the tool as above (including male threads to mate with female threads in the one of the aligned openings and the set of hub engagement elements); step eight 308, choosing an appropriate hub engagement element from the set of hub engagement elements for use in removing the hub wheel bearing assembly based on at least one characteristic of the aligned openings; step nine 309, threading the male threads of the appropriate hub engagement element with the female threads of the one of the aligned openings, thereby attaching the at least one hub engaging element to the hub wheel bearing assembly; step ten 310, engaging the first distal end of the main element with the tool receiver, thereby attaching the main element to the power tool; step eleven 311, attaching the second attachment mechanism to the first attachment mechanism, thereby placing the power tool in communication with the hub wheel bearing assembly; step twelve 312, switching the power tool on; and step thirteen 313, applying a force to the tool via the power tool, the force being transferred to the hub wheel bearing assembly thereby forcing the hub wheel bearing assembly from the steering knuckle. Again, as above, the power tool may preferably be the pneumatic hammer.

It should be noted that certain steps are optional steps and may not be implemented in all cases. Optional steps of method 300 are illustrated using dotted lines in FIG. 10 so as to distinguish them from the other steps of method 300. It should also be noted that the steps described in the method of use can be carried out in many different orders according to user preference. The use of “step of” should not be interpreted as “step for”, in the claims herein and is not intended to invoke the provisions of 35 U.S.C. § 112(f). It should also be noted that, under appropriate circumstances, considering such issues as design preference, user preferences, marketing preferences, cost, structural requirements, available materials, technological advances, etc., other methods for removing hub wheel bearing assembly from a steering knuckle using a tool in combination with a power tool are taught herein.

The embodiments of the invention described herein are exemplary and numerous modifications, variations and rearrangements can be readily envisioned to achieve substantially equivalent results, all of which are intended to be embraced within the spirit and scope of the invention. Further, the purpose of the foregoing abstract is to enable the U.S. Patent and Trademark Office and the public generally, and especially the scientist, engineers and practitioners in the art who are not familiar with patent or legal terms or phraseology, to determine quickly from a cursory inspection the nature and essence of the technical disclosure of the application.

What is claimed is new and desired to be protected by Letters Patent is set forth in the appended claims:

1. A tool for removing a hub wheel bearing assembly from a steering knuckle, the tool for use in combination with a power tool, the power tool including a tool receiver, the hub wheel bearing assembly and the steering knuckle including aligned openings for receiving bolts therethrough, the tool comprising:
a main element including a first distal end opposite a first proximal end and a first shaft therebetween, the first distal end configured for engagement with the tool receiver, thereby attaching the main element to the power tool, the first proximal end including a first attachment mechanism; and
at least one hub engaging element including a second proximal end opposite a second distal end and a second shaft therebetween, the second proximal end including a means of engaging with one of the aligned openings, thereby attaching the at least one hub engaging element to the one of the aligned openings, the second distal end including a second attachment mechanism configured to attach to the first attachment mechanism, thereby placing the power tool in communication with the hub wheel bearing assembly such that a force applied to the tool is transferred to the hub wheel bearing assembly, forcing the hub wheel bearing assembly from the steering knuckle.

2. The tool of claim 1, wherein the main element, the at least one at least one hub engaging element and the one of the aligned openings share a common axis in use, and wherein the power tool is configured to apply a force coaxial to the common axis.

3. The tool of claim 2, wherein the aligned openings each include female threads, and wherein the means of engaging with the one of the aligned openings includes male threads configured for threadable engagement with the female threads of the one of the aligned openings.

4. The tool of claim 3, wherein the power tool is a pneumatic hammer.

5. The tool of claim 4, wherein the first distal end includes a tool-bit shaft for insertion into the tool receiver;
wherein the first distal end further includes a tool-bit collar in between the tool-bit shaft and the first shaft; and
wherein the tool-bit collar is configured to lock the tool-bit shaft into the tool receiver.

6. The tool of claim 5, wherein the first attachment mechanism end includes a protrusion, and wherein the second attachment mechanism includes a socket for receiving the protrusion.

7. The tool of claim 6, wherein the socket includes a hexagonal shaped interior, and wherein the protrusion includes a hexagonal shape exterior configured to conform to the hexagonal shaped interior.

8. The tool of claim 7, wherein the protrusion is secured within the socket via friction.

9. The tool of claim 8, wherein the first proximal end further includes a collar located behind the protrusion, and wherein the collar includes an outer diameter at least substantially equal to an outer diameter of the socket.

10. The tool of claim 9, wherein the at least one hub engagement element includes a set of hub engagement elements, and wherein an appropriate hub engagement element is chosen from the set of hub engagement elements for use in removing the hub wheel bearing assembly based on at least one characteristic of the aligned openings.

11. The tool of claim 10, wherein one of the set of hub engagement elements includes a first size and a first thread pitch.

12. The tool of claim 11, wherein another one of the set of hub engagement elements includes the first size and a second thread pitch.

13. The tool of claim 12, wherein another one of the set of hub engagement elements includes a second size and the first thread pitch.

14. The tool of claim 13, wherein another one of the set of hub engagement elements includes the second size and the second thread pitch.

15. A kit for removing a hub wheel bearing assembly from a steering knuckle, the tool for use in combination with a pneumatic hammer, the pneumatic hammer including a tool receiver, the hub wheel bearing assembly including aligned openings for receiving bolts therethrough, the aligned openings each including female threads, the tool comprising:
a main element including a first distal end opposite a first proximal end and a first shaft therebetween, the first distal end configured for engagement with the tool receiver, thereby attaching the main element to the power tool, the first proximal end including a first attachment mechanism; and
a set of set of hub engagement elements each including a second proximal end opposite a second distal end and a second shaft therebetween, the second proximal end including male threads configured for threadable engagement with the female threads of one of the aligned openings thereby attaching the at least one hub engaging element to the one of the aligned openings, the second distal end including a second attachment mechanism configured to attach to the first attachment mechanism, thereby placing the power tool in communication with the hub wheel bearing assembly such that a force applied to the tool is transferred to the hub wheel bearing assembly, forcing the hub wheel bearing assembly from the steering knuckle; and
wherein one of the set of hub engagement elements includes a first size and a first thread pitch;
wherein another one of the set of hub engagement elements includes the first size and a second thread pitch;
wherein another one of the set of hub engagement elements includes a second size and the first thread pitch;
wherein another one of the set of hub engagement elements includes the second size and the second thread pitch;
wherein an appropriate hub engagement element is chosen from the set of hub engagement elements for use in removing the hub wheel bearing assembly based on at least one characteristic of the aligned openings;
wherein the main element, a chosen hub engaging element and the one of the aligned openings share a common axis in use, and wherein the power tool is configured to apply a force coaxial to the common axis;

16. The kit of claim 15, wherein the first distal end includes a tool-bit shaft for insertion into the tool receiver, and wherein the first distal end further includes a tool-bit collar in between the tool-bit shaft and the first shaft, and wherein the tool-bit collar is configured to lock the tool-bit shaft into the tool receiver.

17. The kit of claim 16, wherein the first proximal end includes a protrusion;
wherein the second distal end includes a socket for receiving the protrusion;
wherein the second attachment mechanism includes the socket having hexagonal shaped interior, and wherein the first attachment mechanism includes the protrusion having hexagonal shaped exterior for mating with the hexagonal shaped interior;
wherein the second attachment mechanism includes the socket having hexagonal shaped interior, and wherein the first attachment mechanism includes the protrusion having hexagonal shaped exterior for mating with the hexagonal shaped interior;
wherein the protrusion is secured within the socket via friction;
wherein the first proximal end further includes a collar located behind the protrusion; and
wherein the collar includes an outer diameter at least substantially equal to an outer diameter of the socket.

18. A method of removing hub wheel bearing assembly from a steering knuckle using a tool in combination with a power tool, the power tool including a tool receiver, the hub wheel bearing assembly and the steering knuckle including aligned openings for receiving bolts therethrough, the tool comprising:
providing the tool including:
a main element including a first distal end opposite a first proximal end and a first shaft therebetween, the first distal end configured for engagement with the tool receiver, thereby attaching the main element to the power tool, the first proximal end including a first attachment mechanism; and
at least one hub engaging element including a second proximal end opposite a second distal end and a second shaft therebetween, the second proximal end including a means of engaging with one of the aligned openings, thereby attaching the at least one hub engaging element to the one of the aligned openings, the second distal end including a second attachment mechanism configured to attach to the first attachment mechanism, thereby placing the power tool in communication with the hub wheel bearing assembly such that a force applied to the tool is transferred to the hub wheel bearing assembly, forcing the hub wheel bearing assembly from the steering knuckle:
engaging the second proximal end of the at least one hub engaging element with the one of the aligned openings, thereby attaching the at least one hub engaging element to the hub wheel bearing assembly;
engaging the first distal end of the main element with the tool receiver, thereby attaching the main element to the power tool;
attaching the second attachment mechanism to the first attachment mechanism thereby placing the power tool in communication with the hub wheel bearing assembly;
switching the power tool on; and
applying a force to the tool via the power tool, the force being transferred to the hub wheel bearing assembly thereby forcing the hub wheel bearing assembly from the steering knuckle.

19. The method of claim 18, further comprising the steps of:
providing the tool wherein:
the aligned openings each include female threads;
the means of engaging with the one of the aligned openings includes male threads configured for threadable engagement with the female threads of the one of the aligned openings;
the at least one hub engagement element includes a set of set of hub engagement elements;
one of the set of hub engagement elements includes a first size and a first thread pitch;
another one of the set of hub engagement elements includes the first size and a second thread pitch;
another one of the set of hub engagement elements includes a second size and the first thread pitch; and
another one of the set of hub engagement elements includes the second size and the second thread pitch;
choosing an appropriate hub engagement element from the set of hub engagement elements for use in removing the hub wheel bearing assembly based on at least one characteristic of the aligned openings;
threading the male threads of the appropriate hub engagement element with the female threads of the one of the aligned openings, thereby attaching the at least one hub engaging element to the hub wheel bearing assembly;
engaging the first distal end of the main element with the tool receiver, thereby attaching the main element to the power tool;
attaching the second attachment mechanism to the first attachment mechanism thereby placing the power tool in communication with the hub wheel bearing assembly;
switching the power tool on; and
applying a force to the tool via the power tool, the force being transferred to the hub wheel bearing assembly thereby forcing the hub wheel bearing assembly from the steering knuckle.

20. The method of claim 19, wherein the power tool is a pneumatic hammer.
